(19) United States
(12) Patent Application Publication
(10) Pub. No.: US 2004/0181454 A1
(43) Pub. Date: Sep. 16, 2004

(54) Web-based point-of sale system

(76) Inventor: Michael Manno, Frankfort, NY (US)

Correspondence Address: Bernhard P. Molldrem, Jr., 333 East Onondaga Street, Syracuse, NY, 13202, US

(21) Appl. No.: 10/386,283

(22) Filed: Mar. 12, 2003

(51) Int. Cl. G06G 1/12; G06F 17/60

(52) U.S. Cl. 705/21

(57) ABSTRACT

A network or web-based point of sale (WPOS) system employs a store server and point-of-sale client computers that are connected over a store LAN or over the Internet to the server. The server provides all necessary operating drivers for cash drawer, scanners, and other point-of-sale peripherals via the web browser of the client computers. An instant kiosk retail solution can involve a remote computer terminal installed via the Internet, and will support peripheral POS devices. The web-based system permits management to obtain store performance reports remotely, and permits customers to schedule and reschedule appointments and delivery times. Servers at two or more store sites can communicate with one another and with a headquarters mainframe. The WPOS can be implemented as an integrated suite for collaboration between store locations.

### BACKGROUND OF THE INVENTION

This invention is directed to a retail transaction control and processing system, and is more particularly related to a network-based point-of-sale system that permits a computer (or other device) that is browser enabled to be used as a point-of-sale station, and which also allows the retail business to manage its store or stores using a local network, a wide area network, or the Internet.

Customer transactions in a retail environment are typically carried out at a point-of-sale station, for example, a “smart” cash register, a self-service terminal, or a transaction kiosk. In a typical retail transaction, a customer picks out one or more merchandise items, and a retail clerk enters the sales data for each item into a point-of-sale device (i.e., a cash register), and then accepts customer payment, either in the form of cash or check, or in the form of a credit card voucher. In modern retail environments the point-of-sale station can include a computer or similar electronic processor, with various associated point-of-sale (POS) peripheral devices, such as a keyboard, a touch-screen monitor, a cash drawer, a pole display, a receipt printer, a scanner for reading UPC bar codes on the merchandise, or a credit card reader. Many other POS devices are possible. The various POS devices or processors may be on-line with an in-store computer.

Point-of-sale systems are also used in connection with retail services, such as automobile repair, heating and air conditioning repair, or any of a wide range of services. In the case of services, it is often necessary to schedule the service for the customer, e.g., routine maintenance of a furnace or installation of a merchandise item (such as a remote starter) in an automobile. In that case, it would be useful to provide automatic, real-time notification of status to the customer, as well as simplifying the actual financial aspects of the sales transaction.

It would be desirable to employ standard, general small computers, i.e. laptop or desk top personal computers, as point-of-sale stations, but in the current technology that would require a special retailing software system to be installed on each computer, and special device drivers would also have to be installed for each POS peripheral device. Then whenever a system upgrade is required, each of the POS stations would have to be individually upgraded with new software.

If is often necessary for a retail store to install additional POS stations, for example, during a store-wide clearance sale, or for special events. In the case of a special sales tent erected outside the main store, it is often necessary for the customer to take merchandise back to a cash register inside the store to pay for the merchandise.

It would be desirable that any additional POS terminal be installed by store personnel without special training, and that the POS terminal operate seamlessly as a stand-alone POS station, employing any or all of a wide array of POS peripheral equipment. However, that has not been possible with the rather complex systems that have been available.

It would also be desirable to have a single unified system that both operates the POS stations for customer transactions and also allows retailers to manage their stores either locally or at remote sites over the Internet.

### OBJECTS AND SUMMARY OF THE INVENTION

Accordingly, it is an object of this invention to provide a web-based, i.e., network based, point-of-sale system in which a standard browser-enabled computer can be employed as a point-of-sale station, and the computer is given access over control of local POS peripheral devices (such as bar code scanners, receipt printers, cash drawer, credit card readers, pole displays, etc.) by means of the web browser installed in the computer.

It is another object to provide a means of home interaction between customer and store, allowing customers to change appointments, check on repair or maintenance progress, obtain back order data, re-print receipts or warranty information for a prior purchase, or other attend to some other post- or pre-retail customer transaction, using a personal computer, or an Internet-enabled device such as a text-message cell phone.

It is a further object to provide a complete architecture for securing the network and sharing information between store locations in a multiple-location retail environment.

It is a still further object to provide a proper information flow for industries that require constant communication between sales staff, management, installers, and customers.

It is a yet further object to provide real-time communication between customers and mobile retailers, and between management and mobile retailers.

It is still another object to provide an instant kiosk solution when an additional point-of-sale terminal is needed, which can be installed without delay or difficulty.

Another object is to provide a partitioned server for establishing low-capital point-of-sale terminals for temporary or small scale retail requirements.

In accordance with an aspect of this invention, a web-based point-of-sale system, or WPOS system, is provided in which a computer at the retail store is programmed and connected with a computer network, i.e., a LAN, a WAN, and/or the Internet, to create a fully functional WPOS that allows general purpose small computers, i.e., personal computers, to connect to the store interface and to serve as point-of-sale stations, and also permits the retail business manager to oversee sales, inventory, and other retail operations over the Internet.

In any of several embodiments, a network based point-of-sale system employs at least one point-of-sale terminal based on a small computer. The computer including the usual means for entering and processing data, means for connecting to said network, one or more ports to which a POS device (i.e., point-of-sale peripheral device) may be connected, and basic software including an operating system and a web browser. The POS devices are operated by the computer in connection with customer sales transactions of merchandise or service. The store server includes a suitably programmed computer including means for connecting with said network, i.e., the in-store LAN or the Internet, and software for accepting POS sales transaction data from each POS terminal. The server supplies whatever data modules and software objects that are necessary over the network to each of said terminals, so that all data entered at each said into said terminal concerning any sales transaction are controlled through the terminal computer web browser. Also, the POS device or devices connected at the terminal are operated through the terminal computer web browser. In many possible embodiments, the server stores sales receipt and warranty information for each customer transaction, and the server software permits customer access to the customer's own receipt and warranty information by the customer connecting to the network, either at one of the in-store WPOS stations, or remotely via the Internet. Preferably, the server software has a capability for automatically notifying a customer of a scheduled delivery or installation of merchandise or service purchased by the customer, by automatic e-mail communication with the customer, or by automated telephone service. The server can also permit the customer to change the scheduled delivery or installation over the Internet. In the case of a cancellation or rescheduling, the availability of time slots is known instantly, making it easier for a customer to select a time that best fits his or her own personal schedule.

In a multiple-store retail environment, a point-of-sale system can involve a main central computer, i.e., a “Mainframe”, a network permitting communication between devices on the network, and also at each store location (i.e., a LAN, a WAN, or the Internet), and at least one point-of-sale terminal at each store location, where the POS terminal employs a computer as described earlier, with a web browser; and one or more associated POS devices to be operated by the computer in connection with a sales transaction of merchandise or service. At each retail store location there is a server computer connecting with the network, and with software for accepting POS sales transaction data from each POS terminal. The server also supplies the required data modules and program objects over the network to each of the associated point-of-sale terminals such that all data entered into each WPOS terminal concerning any sales transaction are controlled through the terminal computer web browser. Also, each of the POS devices connected at each WPOS terminal is operated through the terminal's computer web browser. In this system, the servers at the respective store locations and the main central computer all communicate over the network for collecting sales and inventory data from each of the store locations and sharing said data between store locations. Favorably, the main computer includes manager access software giving an authorized management user access to retail sales and inventory data over the Internet. The main computer can also include customer access software permitting customer access over the network, i.e., over the Internet, and ability to schedule and re-schedule information concerning a scheduled sale or installation of merchandise or service purchased by the customer. Preferably, the customer access software permits the customer to change the time and date of a scheduled delivery or installation of the merchandise or service.

In at least one of the multiple store locations, a customer access computer can be coupled to the network to permit a customer at that store location to access inventory and price data in real time. Here, a barcode scanner provided at the customer access computer lets the customer scan in-store merchandise items. In that case, the server provides the customer access computer with information concerning the merchandise item so scanned, and the customer access computer displays the product information for the customer. The customer access computer is favorably touch-screen actuated, and can display combinations of options and features for the products that the customer is interested in. This information can be printed, downloaded, or emailed. This helps achieve increased customer satisfaction and also boosts sales for the merchant.

When inventory is received at a given store location, the inventory is logged in at the server as soon as the receiving clerk scans in the barcoded information, so that merchandise levels are instantly available for customer requirements. The inventory data for each store is shared with the other store locations, so the customer (or a store clerk) can check on availability at other locations with immediate results.

The WPOS provides a single, centralized management point for store web pages, and for in-house operations. Store management can change prices, look up stock quantities, check customer databases, in real time from any web-connected computer or PDA. Customers or store clerks can print invoices over the Internet, and customers can check appointments and can even be notified via text messaging to PDA or cell phone when a scheduled job is completed.

Because the WPOS system is web-based, management can set up terminals anywhere in the world and have real-time access to the store's database, and can provide the same look and feel as actually being at the store. A kiosk can be set up at a local mall without the need to install any software, and when there is an equipment failure at the point-of-sale, another computer can be substituted to act as the POS terminal, without loss of any sales data. The constant communication over the Internet (or other network) makes the system ideal for any mobile retailer.

The WPOS employs web-based architecture, that is, the WPOS employs an in-store web server, and a database connected with the server that allows each client (i.e., each remote POS station) to connect with the server(s). Each in-store server is then registered with the organizational mainframe system. This allows any store location in the system to query any other store's server that is registered with the main frame. When any machine or server fails, management can simply point their store to another server (at another store or at the headquarters) until repairs are made. The computer will automatically update the down system upon restoration. This creates a seamless network of information and minimal down time.

The WPOS thin-client architecture allows any computer with access to the Internet via web browser to use the WPOS. This means there is no software to install at the point-of-sale, making set up or replacement of a register possible within minutes, even remotely, and makes it possible to install an additional point-of-sale (e.g., a kiosk) at or outside the main store.

The web-based WPOS allows for easy portal integration. The WPOS will run on any convenient operating system, e.g., Unix, Linux, etc., or on a Windows platform. The WPOS client can employ any operating system that runs a web browser. The WPOS can be secured, using secure socket layers (SSL) and session keys, to maintain user state and security. The POS or cash-register mode can operate on a portal within a browser web page, so that a clerk or customer can process a transaction within that portal, while the computer continues to display the remaining portions of the web page.

Store management can also perform their duties remotely accessing the WPOS from home or from a remote site. The remote access devices log into the actual WPOS application, not simply into the database. This allows management at home or at another remote location to see the same look and feel as at the retail environment.

Other advantages are that the WPOS provides in-store local e-mail that can be accessed via Internet for each employee, for management, and for customers. Users can be notified automatically of job status, updates, or other information via Internet, e-mail, text-message cell phone messages, or synthetic speech phone messages. Customers can also reschedule an appointment, or cancel an appointment over the Internet. Customers can buy, schedule, and make changes without involving a “man in the loop”—that is, when the customer interacts with the WPOS, he or she is actually scheduling, rescheduling, or ordering, and not requesting that a scheduled appointment or order later be changed by store staff.

The WPOS allows customers also to look up locations of products within the store, and e-mail themselves store quotes and other product information, using the in-store computer provided for customer use. Customers can also interact with store computers using the store data base and displaying the merchandise of interest, e.g., to find the best combination of options to satisfy the customer's needs. The user can then print a receipt or order form (with barcoded product symbols) from the display, and bring that to the store sales staff to complete a transaction.

A customer can also use the WPOS for “tab billing,” that is, a customer may use a customer ID card to leave the store with merchandise, and then pay the bill later on line using a credit card. One useful application for this feature may be a video rental business.

WPOS can provide staff online training, as determined from data mining results of management back end. Buying patterns of customers, either in-store sales or Internet sales, can be provided easily. Also staff can view real-time store performance via Internet or wireless PDA or cell phone. Mobile retailers (e.g., installers and technicians) can keep instant track of job status and requests. An integrated online scheduler allows for customers to change times and dates of scheduled job orders. Store database and web database can be shared, allowing for management to make changes in store quantities, prices, etc., with such changes being updated instantly at the stores and at the store's web site. Also, management can select which products are sold via Internet, at the store, or both, at the time the product is entered into stock.

The WPOS permits management to track inventory remotely, make remote sales, print receipts, look up customers, view database information, view performance and staff hours, all remotely from any location, via Internet. The WPOS automatically receives upgrades and updates without requiring any software installation. That is, the WPOS can be patched remotely from a vendor, without requiring action within the store. The WPOS provides instantaneous communication between sales staff and installers/technicians.

Importantly, the WPOS is less costly than other systems, resulting in operating cost savings. Since the WPOS is web-based, there are lower credit card processing costs, there is no machine to purchase, and the POS terminals, being standard computers, are less costly than cash register terminals, and WPOS offers full peripheral support for any available point-of-sale peripheral equipment through the web browser of the POS terminal computer. WPOS integrates email, chat and calendars as interoffice collaboration tools. Thus the WPOS is more than a POS terminal, but constitutes an integrated retail office suite, for communication and collaboration.

The above and many other objects, features, and advantages of this invention will become apparent from the ensuing detailed description of a preferred embodiment, which is illustrated in the Accompanying Drawing.

### BRIEF DESCRIPTION OF THE DRAWING

FIG. 1 is a schematic diagram of a multiple retail store point-of-sale arrangement according to one preferred embodiment of the present invention.

FIG. 2 is a perspective view of a POS station of this embodiment.

FIG. 3 is a diagram for explaining customer process flow in accordance with an embodiment of this invention.

FIG. 4 is a diagram for explaining multiple store and remote store process flow, including management interaction, in accordance with an embodiment of this invention.

FIG. 5 is a diagram for explaining pre-purchase and post-purchase customer process flow in accordance with an embodiment of this invention.

FIGS. 6A and 6B show examples of a customer receipt and a store receipt, printed at a POS station of this invention.

FIG. 7 is a schematic diagram for explaining a feature of this invention.

FIG. 8 is another diagram for explaining a feature of the invention.

### DETAILED DESCRIPTION OF A PREFERRED EMBODIMENT

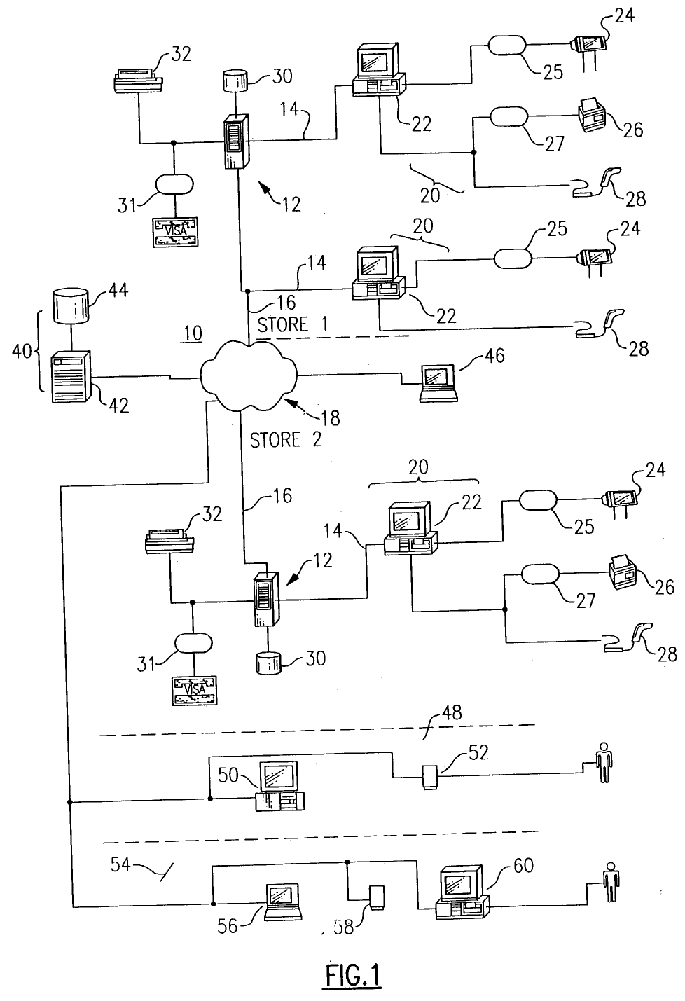

Now with reference to the Drawing, FIG. 1 represents the overall equipment and connectivity of a web-based point of sale system (WPOS) of the present invention. Here is shown a multiple-store WPOS sales and management system 10, in which there is a server 12 located in each store location. At each location, identified here as Store 1 and Store 2, there is an in-store network, i.e., LAN 14 connected with the associated server 12, and the server is also connected via an Internet connection 16 to the Internet 18, here shown graphically as a cloud. Within each store location there is one or more than one point-of-sale station or POS station 20, which comprises a web-enabled computer terminal 22. That is, each computer 22 can be a standard small computer, i.e., laptop or desktop, programmed with a standard software package, including a standard operating system and web browser, such as MS Explorer or Netscape Navigator. Each computer has associated with it a number of POS devices or appliances. Here, these POS devices are shown to include a customer display, i.e., pole display 24, for which a pole display software object 25 is provided through the web browser, and a receipt printer 26, which can be thermal, ink jet, or other printer, and for which a printer software object 27 is provided through the web browser. A bar-code scanner 28 can be provided for checkout of barcoded (i.e. UPN) items. In this case, the software to operate the scanner 28 is also provided from the server 12 through the web browser of the computer 22.

A local database 30 resident at the store location is associated with each of the store servers 12. The server contains a merchant account object 31 for managing credit card purchases, etc., and an associated reports printer 32 can be connected with the server 12 for printing periodic reports and service messages.

At a headquarters site, which can be remote from the store locations, a main computer, i.e., mainframe 40 is connected through the Internet 18 (or other network) to the servers 12 at the store locations. This can include a mainframe processor 42 and a data base 44 containing both current and legacy data for the stores.

Whenever and wherever an additional point of sale is needed, a remote/mobile client computer 46 can be set up as a POS computer. This can simply be a laptop computer, connected directly onto the store LAN 14 or connected through a convenient node to the Internet 18. Then, the computer 46 accesses the store server 12, and operates any associated POS devices (not shown here) via its web browser. The remote/mobile computer 46 can also serve as a customer information station, permitting customers in the store to obtain data concerning availability, scheduling (of maintenance or installation), warranties, prices, etc., and in some cases availability on line for other store locations.

Customer access 48 may be achieved over the Internet 18 from the customer location, i.e., home or office, using a customer computer 50 or other web-enabled device 52, which may be a web-enabled cell phone or personal digital assistant (PDA). This arrangement permits the customer to query the system, i.e., the store server 12 or mainframe 40, as to prices, availability, to schedule or re-schedule maintenance or installation, obtain warranty information, stored purchase receipts, etc. This arrangement also permits the store server 12 to send the customer reminders about scheduled appointments, special sales events, etc., via e-mail or automated phone (voice or data) communications.

An off-site management facility 54 permits store management personnel to monitor store activity and obtain management reports from the store server(s) 12 and/or from the mainframe 40. Here, a management laptop computer 56 is coupled through the Internet 18 to the system 10, or alternatively, the management functions can be carried out from the remote site via a web-enabled cellular phone or PDA 58, or from another computer 60, each being coupled over the Internet to the system 10. The facility 54 can be at any location, and the computer devices 56, 58, 60 can be wired or wireless. This allows management to check inventory levels, sales activity, and other store activity, as well as historical sales data, customer demographics, or other valuable trade information, from any remote location. Access is provided through the web browser of the computer 56 or other device, without requiring any additional or special software to be installed at the remote location. All necessary software is provided from the server through the web browser. A security functionality requires special access codes and PIN numbers for management level access.

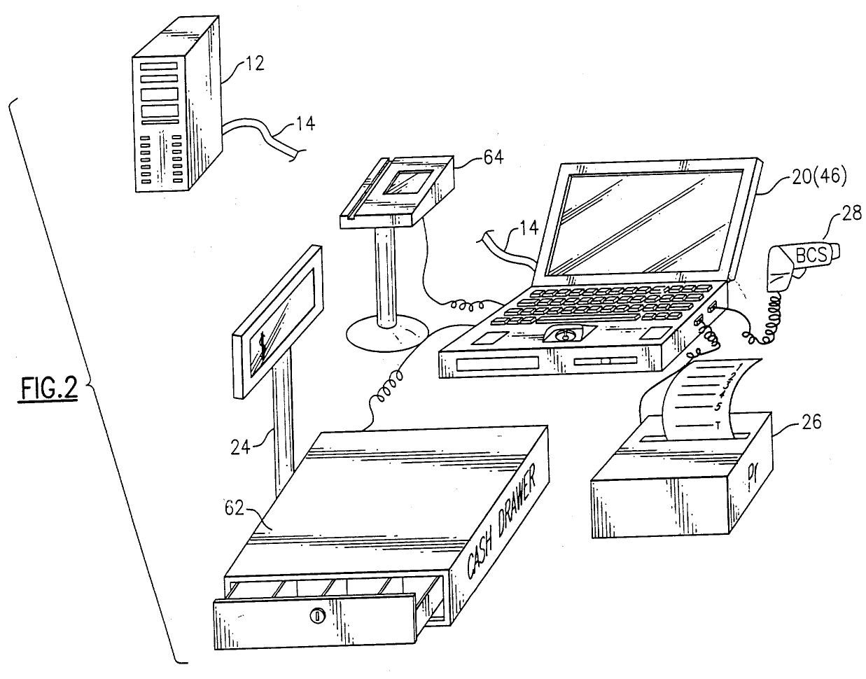

As shown in FIG. 2, a POS station 20 of this invention can comprise a computer 22 (or 46) that is connected to the in-store LAN 14 (or to the Internet 18), and thence to the store server 12. Here are shown the customer display or pole display 24, receipt printer 26, and barcode scanner 28. In this configuration, there is also an electronically operated cash drawer 62 and a magnetic stripe credit card reader 64, both connected with standard cables and connectors to the computer 22 (or 46). The computer 22 is a standard model, and does not require installation of any special software to control any of the POS devices. The server 12 provides all the required software for controlling the peripheral POS devices, so that these are operated through the WPOS computer web browser.

Additional POS devices, not shown here, can include a cash-register keyboard, RF reader, or a bill acceptor and coin acceptor (for customer self-service operation).

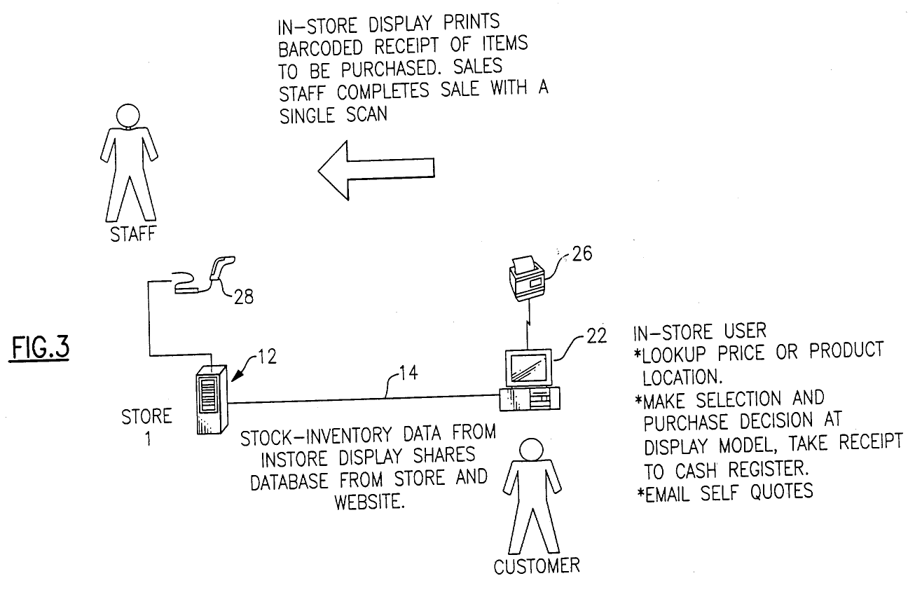

FIG. 3 illustrates an in-store customer process flow in accordance with this invention. Here the customer is permitted access to one of the in-store POS computers 22, which is connected over the in-store LAN 14 to the store server 12. The customer can access information about prices, product locations, features of different product models, and can check the customer's own scheduled maintenance or installation appointments in respect to purchases at that store. For a product that may require pick up, i.e., an appliance, or for installation or other service, the customer may make a selection and purchase decision at the POS computer 22, and the associated printer 26 will print out a receipt or similar order form, which the customer can bring to an attendant at a check-out POS station (i.e., a cash register). The receipt can be printed with a barcode to facilitate delivery of the correct merchandise. The in-store computer 22 and printer 26 print out a barcoded receipt for items to be purchased, and a sales attendant can then complete the purchase with a single scan. Here, a scanner 28 is shown for use by the staff or attendant for this purpose. The stock or inventory data for this in-store display computer 22 shares the same database as the other units in the store, and with a website which the consumer can view at home using the Internet. In this case, the consumer is provided with access at a minimum security level, and can access the store database, using the web browser on the computer 22, only for limited purposes. However, the system can be configured to permit the customer or other user to e-mail quotes or other information to his or her own home or office.

The scanner 28 is also used for scanning in barcodes when inventory is brought into the store. This puts the updated information about product availability and inventory levels immediately at the hands of management, and can immediately respond to a customer query about availability of a given item.

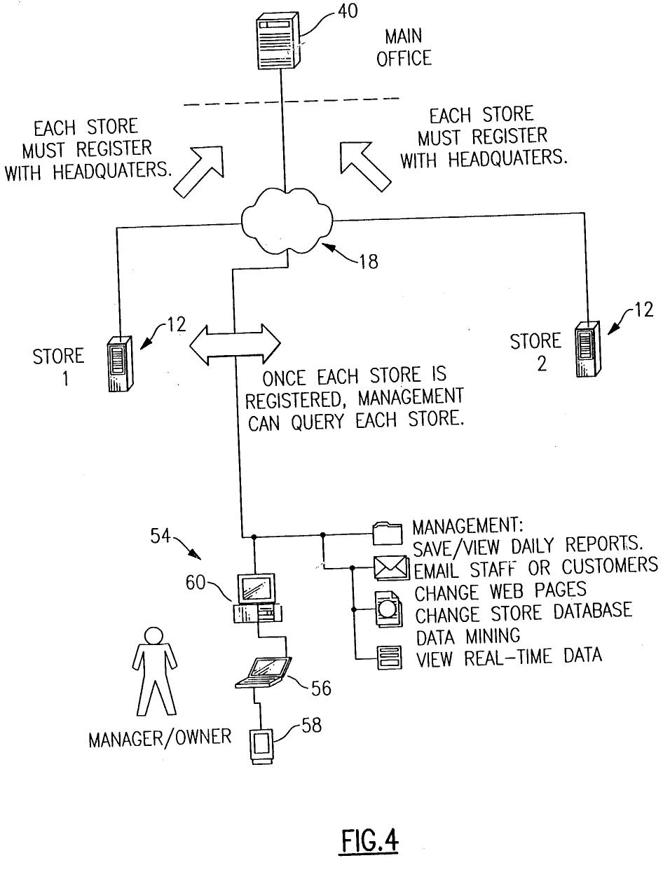

A management functionality for a multiple-store configuration is illustrated in FIG. 4. Here, as discussed in respect to FIG. 1, there is a Store 1 server 12, a Store 2 server 12, and a headquarters office mainframe computer 40, which connect with one another over the Internet 18, together with local network or networks 14 (not shown here). At initial installation of the store servers 12, each store registers with the headquarters main frame computer 40. Then, once the store servers are registered, the information stored on each of the servers 12 is available on the system for management purposes. At a management location 54, which can be anywhere where there is access to the Internet 18 (or to a LAN at either store location or at the headquarters location), an authorized management employee or officer can access the WPOS system using a standard Internet or web-enabled device such as laptop computer 56, PDA or cell phone 58, or desktop computer 60. As with other implementations previously discussed, the computer device accesses the WPOS system through the computer's web browser. The management employee or officer is provided with a higher level of access, via an access code, PIN, or the like. At the management location, it is possible to view (and print or save) daily or other periodic management reports, as well as to obtain specific management related information. The management employee or officer can write and send email messages to staff or customer, or receive same; to create or alter web pages on the store web sites; to obtain sales and demographic information, i.e., ‘data mining’; or to view any other commercial data for either store location in real time.

Off-site customer access to information in the WPOS system can be explained in reference to FIG. 5. Here, the WPOS system is multiple store system with store servers 12, and headquarters mainframe computer 40, coupled via the Internet 18 to one another and to a customer home or office computer at the customer location 48. The customer computer can be any suitable web-enabled device, e.g., standard desktop computer 50, laptop computer 51, or PDA/cell phone 52. At the time of a purchase or order entry by the customer, the customer's email address and/or phone number is entered into the system. The server 12 from the store where the customer interaction took place can then automatically text-message, call, or e-mail the customer when a particular job is completed, or when an order is ready for pickup or delivery. By entering a customer access code that the store provides the customer, the customer can access the WPOS system via a computer web browser, and he or she can view updates of the customer's purchases and account information, in real time; view (and download or save) manuals relating to equipment that the customer has previously purchased; access a custom store web portal in which the customer can view sales activity; schedule or change appointments, deliveries, or installations; and print receipts from prior purchases. The customer can also tailor the types of messages he or she wants to receive from the store, e.g., messages relating to certain types of merchandise, equipment, or services. In many type of service transactions, such as automotive repair, the customer may be able to check on the status of the job over the WPOS system, thus relieving a staff person from having to answer phone calls about job status. The customer may remotely access the store server for the purpose of making a ticketed reservation, i.e., for an airline or rail transportation, or for a movie, play or concert, and may revisit the customer access site later to change the reservation data, i.e., times, seating arrangements, etc., without involving human intervention on the part of the merchant. The server 12 can contain the capability of delivering a suitable barcoded symbol to the customer computer, which can be printed out on the customer computer and then brought with the customer to the transportation terminal or the movie or other event, where it is scanned for admission of the customer. Previous purchases may also be canceled or modified by the customer (before delivery) and the customer can also change delivery times and locations, also without involving the intervention of store personnel.

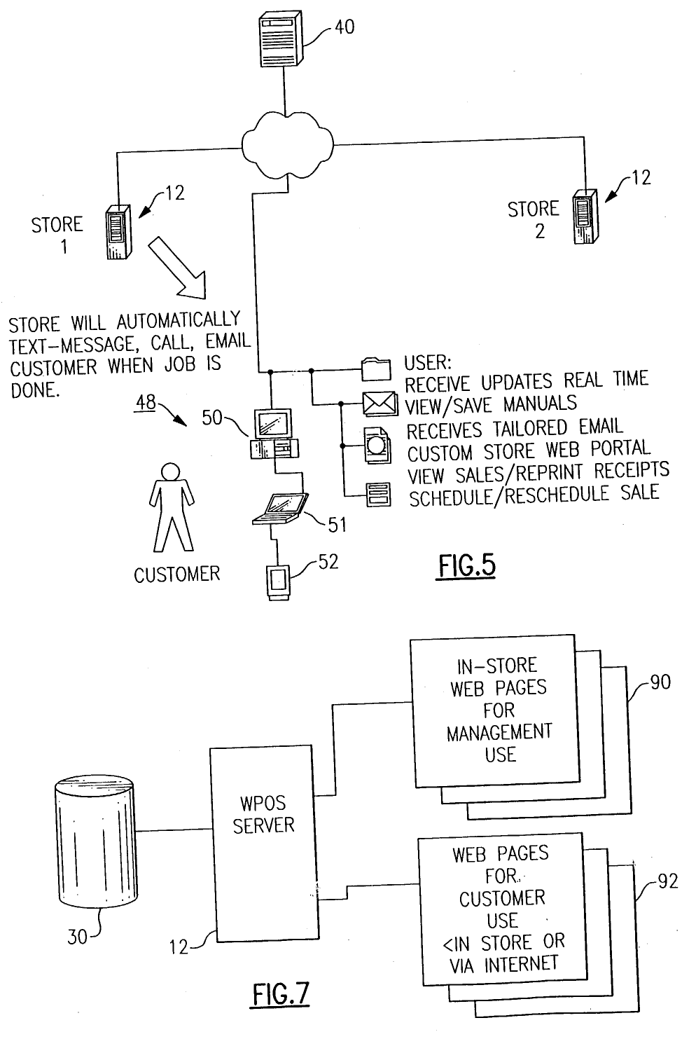

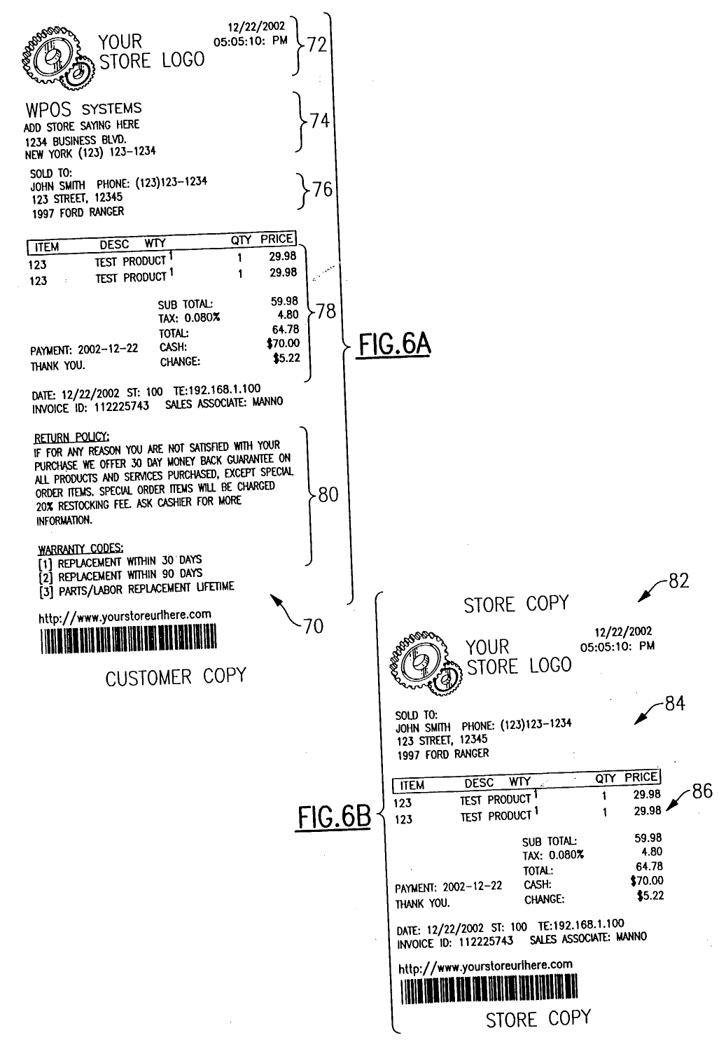

The printer 26 can print out a customer receipt 70, an example of which is shown in FIG. 6A. Here, the data are printed out in various fields. In a first field 72 is a scheduled appointment reminder, which can be for servicing or installation of some customer product. Below that is a field 74 that identifies the store, with the store address and telephone number, with customer identification and address, etc., in another field 76. The items purchased and their quantities, prices, warranty codes, and other product information are printed in a next field 80, together with date, store number, clerk or sales associate identification, and an ID number for later tracking. Other fields can be provided as necessary, e.g., a field for printing warranty codes, and a transaction tracking barcode. The layout and types of fields can all be customized by management from either a local or remote site, using the management computer with its web browser, and providing the required access codes. The WPOS prints out two copies of receipts, one for the customer and one for the store.

As shown in FIG. 6B, the printer also prints out a store receipt 82 for the same transaction, and the store receipt 82 is retained by the merchant. The store receipt 82 has a field 84 that identifies the particular customer, and another field 86 that contains the purchase data, i.e., a list of merchandise, price, amount paid, and mode of payment.

As shown in FIG. 7, each store server 12 has a capability of delivering both in-store web pages 90 for management use, and customer web pages 92 for customer use. Each of these sets of web pages can be accessed in-store or from a remote computer, with the management web pages 90 requiring a management access code. As shown here, the server is provided with the entire store database 30.

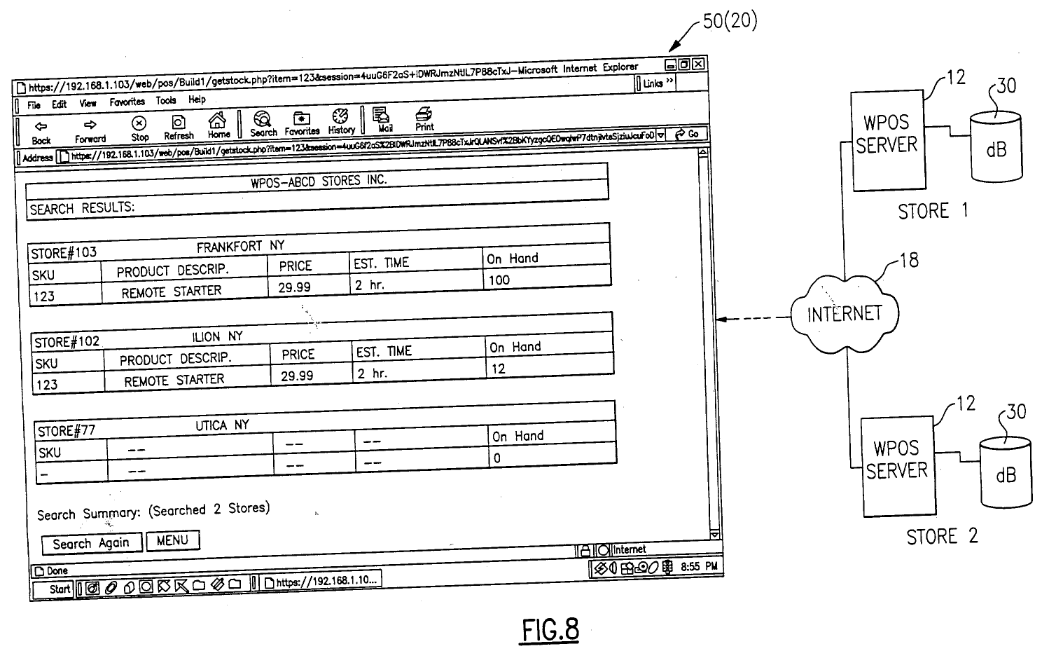

The customer may use either the in-store computer station or his own home computer to check on availability of product at any number of store locations within a reasonable driving distance. As shown in FIG. 8, the customer can access the databases 30 and store servers 12 at a number of store locations via the Internet 18. That is, the software that is accessed by the customer's web browser at the home computer 50 (or store computer 20) will query the various store locations within the system, and display the results from several convenient locations. In the illustrated example, a customer has queried about the availability of a remote starter, and the display shows that for three store locations (selected by customer preference, i.e. geographic range), there are 100 units in stock at the store #103 location, 2 units at the store #102 location, and none in stock at the store #77 location. After this, the customer can automatically place a “hold” for one of the units at either of the stores, so that there will be one available for him to pick up and purchase. This has all been done without involving any clerical or store personnel.

The web-based point-of-sale architecture of this invention is a “thin client” configuration. No software installation is involved at the point-of-sale computers, for all the necessary functionalities and software objects are provided from the server, and are accessed via the web browser. The means there is only a single interface to learn. The system involves a secure network, e.g., using SSL and session keys. Site-wide email (i.e., in-store messaging) is available. The WPOS system allows online, real-time customer tracking, and achieves more efficient credit card processing, complete remote management capability, remote software maintenance and upgrade capability, and a provision for database mining.

Peripheral support is provided without having to install device drivers, as these are provided from the server over the WPOS station web browser. The system will support, among other devices: bar code scanners; thermal printers; pole displays; touch screen displays; credit card readers; ID card readers; magnetic stripe gift certificate card machines; and cash drawers. The WPOS system is compatible with various web appliances, creating a portable solution for such tasks as inventory tracking, remote sales, remote printing of receipts, and viewing the store database, employing cell phones, PDAs, laptop computers, or the like, either wired or wireless.

In the WPOS system, the store Internet web page and the store WPOS system can share a single database. Customer web access is provided for job status, product availability and prices, or other customer information. An event scheduler can accompany each sale. Real time communications is achieved between management and staff.

The WPOS provides management with a straightforward and immediate kiosk solution for a busy season or special sales event, e.g., at a local mall. Using the web-based interface, an additional remote terminal can be set up instantly, and will have the same information as the parent store. Also, sales at the kiosk WPOS are instantly known at the store server.

Many other solutions can be achieved using the WPOS of this invention.

Where management receives a phone call for a product or supplier request, management can then simply look into the database of the requested store, query the database, and return the call within a few minutes. If management is interested in the daily activities during a busy day, management can query to see the amount that should be in the cash drawer(s), and then can visit the store to count the cash and compare the amount against the daily or interim report. If management needs equipment to be repaired or serviced, and has to rely on an installer for a problem fix, the WPOS provides for instant communication between the installer(s) and staff.

In case a customer needs a receipt, but has lost the receipt, the customer can log on to the store web site and re-print the receipt. Where the customer must reschedule an appointment or installation time, the customer can log in to the web site and reschedule without store or staff assistance. The store server will automatically send out a reminder email to the customer about the re-scheduled appointment.

Where the customer is interested in a product and the price of that product, he or she can use the in-store locator computer to locate the product, and then e-mail himself or herself a product price or quote, plus any product details or product options of interest. Where the customer is or may be interested in a product combination, e.g., a television and VCR, the user can interact with the in-store locator to display the products, and select the combination that appears to be the best fit. Then the customer can print out an order form with bar codes for those products, and bring the order form to a service register where a retail staff member can scan it and complete the purchase transaction. In a vehicle service or vehicle installation environment, i.e., installation of new tires, annual check-up and inspection, or installation of a remote starter, for example, the user can drop off the vehicle, and the WPOS will notify the customer, by cell phone message or email, of the estimated completion time. Later, the WPOS will notify the customer of job completion.

In an alternative arrangement, a WPOS system with a single server 12 can be used for a number of different merchants, each with his or her own point-of-sale computer. In that case, the server can be partitioned so that each subscribing merchant will have access only to his or her own accounting and inventory information. One possible example where this can be used is a small-scale or start-up retail business, where only a single POS or cash register would be needed. Then space on the server 12 can be rented temporarily or on a long term basis. Other partitioned space on the same server could be rented out to other similar businesses. Another example is in a craft fair or “flea market” environment, where many independent merchants would be present at a single retailing location. Also, WPOS can perform as a subscription service for companies to connect remotely to a staged WPOS server that is maintained by a WPOS management service. This would permit the small-scale business to subscribe to WPOS for a monthly fee, instead of having to purchase a WPOS server. A small business, a business under construction, or any business that feels an in-store server is not necessary, might be interested in subscribing to a remote WPOS server, if the business's connection (i.e., Internet speed) supports it.

WPOS can be used to advantage for mobile repairs or installations, and WPOS can be used with GPS systems navigation to easily locate customers and provide instantaneous, real-time notification of any given installer's location.

WPOS provides the advantages of store collaboration, using WPOS integration of the following:

E-mail—pay stubs, forms, files, required reading;

Web Training—learning about products, store changes, policy updates;

Chat—communicating with other staff members with question-and-answer chat;

Online form processing—filling out required information (tax forms, etc.)

Calendar—marking important dates, requesting a day off, etc.;

Staff Forum/Message Board—Permitting staff to communicate and reply to topics;

Web Browsing—surfing the Internet, connecting to other web-based systems, all within WPOS;

Rolodexing—Permitting store management to always have access to their contact information on hand, remotely dialing into the store to obtain the contact data or to add to it.

While the invention has been described with reference to a preferred embodiment and various alternatives thereto, it should be apparent that the invention is not restricted to such embodiment(s). Rather, many variations would be apparent to persons of skill in the art without departing from the scope and spirit of this invention, as defined in the appended claims.

I claim:

1. Network based point-of-sale system comprising a network permitting communication between devices connected to the network; at least one point-of-sale terminal which includes a computer, the computer including means for entering and processing data, means for connecting to said network, one or more ports to which a POS device may be connected, and software including a web browser; and one or more POS devices to be operated by the computer in connection with a sales transaction of merchandise or service at said terminal; and a server including a suitably programmed computer including means for connecting with said network, and software for accepting POS sales transaction data from each said terminal, and supplying modules over said network to each of said terminals such that all data entered at each said into said terminal concerning any sales transaction is controlled through the terminal computer web browser, and each said POS device connected at said terminal is operated through the terminal computer web browser.

2. Point-of-sale system according to claim 1 wherein said POS devices include one or more of a cash drawer, a credit/debit card reader, a bar code scanner, a pole display, and receipt printer.

3. Point-of-sale system according to claim 1 wherein said server stores sales receipt and warranty information for each customer transaction, and said server software including means permitting each customer can access the customer's own receipt and warranty information by the customer connecting to said network.

4. Point-of-sale system according to claim 1 wherein said server includes means for notifying a customer of a scheduled delivery or installation of merchandise or service purchased by said customer, by automatic e-mail communication with said customer.

5. Point-of-sale system according to claim 1 wherein said server includes means for notifying a customer of a scheduled delivery or installation of merchandise or service purchased by said customer by automatic phone communication with said customer.

6. A multiple store point-of-sale system comprising
a main central computer,
a network permitting communication between devices on the network, and, at each store location,
at least one point-of-sale terminal which includes a computer, the computer including means for entering and processing data, means for connecting to said network, one or more I/O ports to which a POS device may be connected, and software including a web browser; and one or more POS devices to be operated by the computer in connection with a sales transaction of merchandise or service at said terminal; and a server including a suitably programmed computer including means for connecting with said network, and software for accepting POS sales transaction data from each said terminal, and supplying data modules over said network to each of the associated point-of-sale terminals such that all data entered into each said terminal concerning any sales transaction is controlled through the terminal computer web browser, and each said POS device connected at said terminal is operated through the terminal computer web browser; and
means communicating between the servers at the respective store locations and said main central computer for collecting sales and inventory data from each of the store locations and sharing said data with the other said store locations.

7. Multiple store point-of-sale system according to claim 6 wherein said main computer includes manager access software permitting an authorized management user to access said sales and inventory data over the Internet.

8. Multiple store point-of-sale system according to claim 6 wherein main computer includes customer access software permitting customer access over said network to schedule and re-schedule information concerning a scheduled sale or installation of merchandise or service purchased by said customer.

9. Multiple store point-of-sale system according to claim 8 wherein said customer access software permits the customer to change the time and date of a scheduled delivery or installation of the merchandise or service purchased by said customer.

10. Multiple store point-of-sale system according to claim 6 at least one of said store locations including a customer access computer coupled to said network which permits a customer at said store location to access inventory and price data.

11. Multiple store point-of-sale system according to claim 10 wherein a bar code scanner is provided associated with said customer access computer permitting a customer to scan in-store merchandise items, said server provides the customer access computer with information concerning the merchandise item so scanned, and said customer access computer displays said information for the customer.

12. Multiple store point-of-sale system according to claim 6 further comprising means at each said store location for updating inventory data on the associated server when a shipment of merchandise is received, and communicating the updated inventory data over said network to said main central computer.

13. Network based point-of-sale system permitting individual merchants to employ web-enabled computers as point-of-sale terminals, and in which a network permits communication between such computers and a server connected to the network; wherein each said point-of-sale terminal comprises a computer, the computer including means for entering and processing data, means for connecting to said network, one or more ports to which a POS device may be connected, and software including a web browser; and one or more POS devices to be operated by the computer in connection with a sales transaction of merchandise or service at the associated point-of-sale terminal; and said server including a suitably programmed computer including means for connecting with said network, and software for accepting POS sales transaction data from each said point-of-sale terminal, and supplying modules over said network to each of said terminals such that all data entered at each said into said terminal concerning any sales transaction is controlled through the terminal computer web browser, and each said POS device connected at said terminal is operated through the associated point-of-sale terminal computer web browser.

14. The network-based point-of-sale system according to claim 13, wherein said server is partitioned so that sales data for each point-of-sale terminal are segregated and not shared with the remaining point-of-sale terminals.

15. The network-based point-of-sale system according to claim 14, wherein said partitioned server is configured to permit a plurality of merchants to access respective areas of the server independently on a subscription basis.

16. The network-based point-of-sale system according to claim 13, wherein said server includes means to permit customers to log into the server to purchase event or transportation tickets and means providing machine readable indicia to be printed out by the consumer and which can be scanned to admit the customer at the transportation or event.

17. The network-based point-of-sale system according to claim 13, further comprising means permitting a customer to access that customer's purchase data on the server remotely, and to modify purchases or reschedule deliveries without intervention of store personnel.
